(19) United States
(12) Patent Application Publication
(10) Pub. No.: US 2012/0158450 A1
(43) Pub. Date: Jun. 21, 2012

(54) METHOD FOR CREATING A MARKET GROWTH STRATEGY

(75) Inventors: ANTHONY W. ULWICK, ASPEN, CO (US); LANCE BETTENCOURT, BLOOMINGTON, IN (US); RICHARD NORMAN, WILMINGTON, NC (US); URQUHART WOOD, WESTERVILLE, OH (US)

(73) Assignee: ANTHONY W. ULWICK, ASPEN, CO (US)

(21) Appl. No.: 12/253,433

(22) Filed: Oct. 17, 2008

Related U.S. Application Data
(60) Provisional application No. 60/980,854, filed on Oct. 18, 2007.

(51) Int. Cl. G06Q 30/00

(52) U.S. Cl. 705/7.25; 705/7.31

(57) ABSTRACT

A computer program product and business method is described for generating a market growth strategy. The computer program product in a computer-readable medium having instructions for directing a computer to focus on the core job that needs to be performed. A specific sequence is executed in several phases: market selection, target generation, business generation and portfolio generation strategies. Inputs are tailored to the outcomes that are desired for each phase and cover customer(s), company(-ies) and society. Three aspects (job, job executor and platform) are transformed by the instructions to generate six potential growth paths A market growth strategy is built around these potential growth paths. The business method and program product receives, stores, and manipulates this data using storage for input, desired outcomes and output data.

### BACKGROUND OF THE INVENTION

1. Field of the Invention

The present invention relates generally to strategies utilized to maintain or generate company growth, and more particularly to specific methodologies and analytical techniques for creating market growth strategies.

2. Description of the Prior Art

U.S. Pat. Nos. 5,963,910 and 6,115,691 issued to Anthony Ulwick are entitled Computer Based Process For Strategic Evaluation and Optimization Based On Customer Desired Outcomes and Predictive Metrics, and teach of computer based data management systems, and more particularly, to a computer based data integration and management processing system and method for evaluating and optimizing personal and business strategies; these patents (U.S. Pat. Nos. 5,963,910 and 6,115,691) are hereby incorporated by reference. The inventions described therein disclose technology that enables individuals and businesses to evolve their decision-making capabilities far beyond their current capacity. The methods expand an individual's capacity to process and apply thousands of pertinent facts when making complex personal and business decisions. The inventions taught comprise a user-friendly computer program product that enables a user to analyze complex situations, objectively evaluate alternative solutions, and create and optimize personal or business strategies.

The computer program product allows the user to choose from a variety of missions. A mission is a particular task, project, or decision which an individual, employee, or business is contemplating. Upon selection of a specific mission, the data, including statements that define the criteria for creating value are retrieved from a database along with other pertinent facts that are critical to objective decision making. The user is then led through a process that enables the development of solutions and strategies that deliver many times more value than could normally be achieved.

U.S. Pat. No. 6,085,165 issued to Anthony Ulwick, is entitled Process and System for Outcome Based Mass Customization. Therein is disclosed a system and process for configuration and optimization of an electronic device wherein a user is presented with, and prioritizes, device specific desired outcomes, whereafter a computer subroutine prioritizes the desired outcomes and corresponding predictive metrics and device features. This results in a set of implementation commands that are then transmitted to the device that automatically configures customizable features accordingly such that the device is customized based on the user's prioritized desired outcomes.

Aside from the Ulwick technologies referenced above, it should also be noted that individuals and organizations often choose strategies that have worked for someone else. This approach is seldom successful as it ignores the desired outcomes that make that specific situation unique. The optimal strategy for a specific strategic situation is rarely a generic strategy as it is unlikely that the individuals involved, and their desired outcomes, are the same in any two strategic situations.

As the limitation of the human mind is well recognized, there is found in the prior art a number of methods and systems for designing, planning, manufacturing and evaluating the development of goods and services. However, none of these addresses nor solves the problems noted herein.

For example, U.S. Pat. No. 5,041,972 issued to Frost and entitled “Method of Measuring and Evaluating Consumer Response for the Development of Consumer Products”, discloses a method for evaluating consumer response. This patent relates to methods for performing market research that involve measuring and evaluating the responses of consumers or of the relevant audience to consumer products which are to be marketed or presented to the audience, the members of which are in a position to choose between the items. The object of such methods is to determine how members of the audience will react to the introduction of new products to the market or to changes in the characteristics of an existing product. Marketing strategies can then be based upon the data obtained therefrom.

U.S. Pat. No. 5,416,694, issued to Parrish et al., teaches a computer based data integration and management process for work force planning and occupational free adjustment. Parrish teaches a system and method using a number of databases that are either created internally or are imported from existing databases. These databases are manipulated by the invention or skill matching analysis based on a rigorous behavioral skill analysis of target occupations, using one or more predetermined analysis metrics and an examination of individual skills using metrics with similar behavioral attributes.

Additionally, authors of some of the more popular business books related to strategy and innovation, including those authored by John Kotter, Clayton Christensen, Adrian Slywotzky, and W Chan Kim, discuss various types of strategies that can be pursued to maintain and/or generate company growth. However, none these authors propose a systematic approach for creating market growth. In fact, many academics and thought leaders believe that innovation required for market growth is inherently a disorderly, trial-and-error process—and cannot be organized.

Currently market growth strategies are not developed using a structured process or any process at all. Market growth strategies are often developed through a set of ad hoc decisions where all the needed inputs have not been identified and many of the decisions are made out of order and/or by personnel without the knowledge and/or authority to insure implementation. Companies compensate for these shortcomings by going back and readdressing the decisions made until all the needed inputs have been flushed out and managements buys in to the plan. These iterations in decision making delay the development and implementation of the market growth strategy and often has the unintended consequence of creating competing implementation plans within the business.

This lack of a universal, structured and predictable methodology makes it impossible for companies to consistently formulate effective market growth strategies, despite the fact they spend millions of dollars on researching customers' needs, researching new technologies and developing new products. Further, it was discovered that companies are currently conducting the strategy and innovation process to drive market growth in the wrong sequence and with the wrong inputs. This turns it into a trial-and-error, iterative process that produces inconsistent and unpredictable results. Thus, a method for devising a market growth strategy for any market—and achieving growth through innovation—is needed.

Consequently, the present invention is directed at overcoming the disadvantages and shortcomings of the prior art by providing a universal, structured and predictable methodology to formulate effective market growth strategies.

### SUMMARY OF THE INVENTION

This invention is a unique and systematic method for devising a market growth strategy. The output of this process is a set of product and/or service concepts that create value for a customer and profitability for a company. This method is unique in that it (1) includes all the steps needed to produce a successful result; (2) sequences the steps in the correct order—ridding the process of unneeded iterations; (3) uses the correct process inputs—inputs that are not ordinarily known or available; and (4) introduces the inputs into the process at the right time—much earlier in the process than traditionally introduced. By executing all the steps in the prescribed order using the prescribed inputs, the process becomes linear and predictable.

In accordance with the foregoing, the instant invention provides a computer program product implemented in a computer readable medium comprising the software instructions to generate the market growth strategy. This strategy overcomes the aforementioned deficiencies found in the prior art by concentrating on the core job that needs to be performed. To ensure that optimal results are achieved a specific sequence of software instructions are executed in several phases as follows: first select a market, then generate a targeting strategy, then generate a business strategy and finally generate a portfolio or product strategy. Each of these phases and corresponding instructions within each phase require inputs tailored to the outcomes that are desired for each phase; these inputs are accepted from a variety of sources including: customer(s), company(-ies) and society. Additional information is utilized by the software instructions on the computer readable medium to cover job(s) related to the core job as well as a new value delivery platform related to a core platform, a job executor and a new job executor (or customer). These three aspects (job, job executor and platform) are transformed by the instructions of the computer program product to generate six potential growth paths. Then a market growth strategy is built around these potential growth paths as taught in the invention. In general, the computer program product on the computer readable medium receives, stores, and manipulates this data; thus, the market growth strategy taught by this invention enables individuals and businesses to broaden their perspective in the marketplace. It also enhances and optimizes the decision-making ability of the foregoing far beyond their current capacity by taking into account a specific sequence of programming instructions and all relevant variables and concerns that can affect a job.

In accordance with these and other objects that will become apparent hereinafter, the instant invention will now be described with particular reference to the accompanying drawings.

### BRIEF DESCRIPTION OF THE DRAWINGS

FIG. 1 is a diagrammatic representation of the overall sequential process steps utilizing the methodology of the instant inventions.

FIG. 2 is a flowchart representing the generation of a targeting strategy 110 utilizing the methodology of the instant inventions.

FIG. 3 is a flowchart representing the generation of a business strategy 120 utilizing the methodology of the instant inventions.

FIG. 4 is a flowchart representing the generation of a portfolio product strategy 130 utilizing the methodology of the instant inventions.

FIG. 5 is a diagrammatic representation of platforms and potential options utilizing the methodology of the instant inventions.

FIG. 6 is a graphical representation of defined scores and outcomes for a first growth path.

FIG. 7 is an alternative graphical representation of defined scores and outcomes for a second growth path.

FIG. 8 is an alternative graphical representation of defined scores and outcomes for a new platform for a growth path.

FIG. 9 is an alternative graphical representation of defined scores and outcomes for a third growth path.

FIG. 10 is an alternative graphical representation of defined scores and outcomes for a new platform for a fourth growth path.

### DESCRIPTION OF THE PREFERRED EMBODIMENTS

It is important to note that these embodiments are only examples of the many advantageous uses of the innovative teachings herein. In general, unless otherwise indicated, singular elements may be in plural and vice versa with no loss of generality. In the drawings, like numerals refer to like parts through several views.

### User Input:

The following are different inputs that are utilized throughout the invention and are listed below for early consideration.

### User Inputs for 200 Include

1. The set of customers in the customer chain, e.g., a raw material supplier, manufacturer, distributor, service provider (installer, maintainer, job executor, disposers), a user (job executor).
2. The target audience (demographics of a population) within a customer set (e.g., chemist in for a raw material supplier, orthopedic surgeons, teens in the USA).
3. A situation or circumstance that the targeted audience experiences, e.g., chemist who work with hazardous materials, orthopedic surgeons who are inventors, teens while away from home
4. The job(s) of focus that the target audience performs in that defined situation, e.g., the job of ensuring hazardous material does not contaminate ground water that chemists who work with hazardous materials perform, the job of commercializing an invention that orthopedic surgeon inventor perform, the job of staying in touch with friend that teens perform while away from home. These job(s) of focus that the target audience performs are referred to as the ‘core job(s)’.

The process prompts a user to provide importance and satisfaction scores for each of the customer sets in the customer chain for the job that they perform as inputs to the invention. The invention then determines which of these target audiences or ‘core jobs’ provides the best opportunity to create a market growth strategy.

### User Inputs for 210

For a selected customer set in the customer chain (e.g., the job executor), and the selected ‘core’ job that job executor performs, the process prompts a user to select consumption chain jobs related to executing the ‘core’ job that was selected. These selections are used as part of the input for 220.

### User Inputs for 220

The method prompts a user to input a list of jobs and outcome statements collected from the target audience in 200, the importance and satisfaction scores measured for the job and/or outcome statements, the number and a description of the people that provide the importance and satisfaction ratings for those statements, and the criteria that will be used to generate segments of respondents that have similar characteristics. These characteristics could be, but are not limited to demographic criteria, circumstances under which they perform a job, and/or a similar group of job and/outcome statements that are under or over served.

The computer will prioritize the job and outcome statements based on an opportunity score calculated from an opportunity algorithm to identify the most underserved job and/or outcomes. The invention process will also identify which of the job and/or outcome statements are overserved (importance score<satisfaction score) and appropriately served (importance=satisfaction score within experimental error of the importance and satisfaction score measurement). The invention will generate the opportunity scores for segments of the total population studied defined by the criteria provided by the user as well the size of those segments within the total population studied and a description of the type of respondent in each segment. The output of this step is used in 230.

### User Input for 230

In order to select the segments, opportunities and growth paths to target, the process requires the user to determine which jobs and outcomes are currently or can be impacted with the capabilities of value delivery platforms used by the job executor. Also, the user provides inputs on potential new job executors. These could be people that benefit from the core job being executed but do not execute the job themselves because they do not possess the skills, time or equipment needed to execute the job (a person who has their teeth whiten by a dentist), or people that are both the job executor and the job beneficiary that can now hire a service to perform the job for them (a homemaker that prepares a meal that now has a food service company prepare a meal for the home).

The method prompts the user to provide inputs of the selection criteria to determine if a segment of the market should be considered. For example, some, but not all, of the selection criteria may consist of a target number (e.g., a minimum number, the maximum number) of job and outcome statements that are underserved, a target number (e.g., a minimum number, the maximum number) of job or outcome statements that are overserved, a target number (e.g., a minimum number, the maximum number) of job and/or outcome statements that have an opportunity score above a threshold value (e.g., opportunity score≦10.0), a target number (e.g., a minimum number, the maximum number) of jobs/outcomes that have an importance score below a threshold value (e.g., importance score≦3.0), a target number (e.g., a minimum number, the maximum number) of job and outcome statement that both above a threshold value and unique to a segment, a demographic characteristic of the population (e.g., household incomes of $50,000 to $74,999), the size of a segment (e.g., 28% of the broad market), the profile the people that make up a segment (e.g., spends 10 hours/day or more away from the house).

The computer identifies the outcome statements that are both underserved and impacted by the current platform, which outcomes are both overserved and impacted by the current platform and which outcomes are both appropriately served and impacted by the current platform (Growth Path 1).

The computer identifies the job statements that are both underserved and impacted by the current platform, which jobs are both overserved and impacted by the current platform and which jobs are both appropriately served and impacted by the current platform (Growth Path 2).

The computer identifies the job statements that are both underserved and can not be impacted by the current platform, which jobs are both overserved and can not be impacted by the current platform and which jobs are both appropriately served and can not impacted by the current platform (Growth Path 3).

The computer identifies the outcome statements that are both underserved and can not be impacted by the current platform, which outcomes are both overserved and can not be impacted by the current platform and which outcomes are both appropriately served and can not impacted by the current platform (Growth Path 4).

The computer identifies which outcome statements are underserved and need a new platform that enables a new job executor to perform the job, which outcomes are overserved and need a new platform that enables a new job executor to perform the job, and which outcomes are appropriately served and need a new platform that enables a new job executor to perform the job, (Growth Path 5).

The computer identifies which job statements are underserved and need a new platform that enables a new job executor to perform the job, which jobs are overserved and need a new platform that enables a new job executor to perform the job, and which jobs are appropriately served and need a new platform that enables a new job executor to perform the job, (Growth Path 6).

The output of this step is inputted into 300 and/or 320.

### User Inputs for 240

The process prompts a user to input the time frame in which a concept created on the current platform or a new platform concepts need to be available to deliver to the market, the targeted cost goals to deliver the product/service, and the targeted price that market is expected to pay for the product/services delivered to the market in the specified timeframe.

The output of this step is inputted in 330.

### User Input for 250

The method prompts a user to input a weighting for each company criteria and the threshold values that a concept should meet in order for the company to support the creation of a product or service concept. These inputs are provided for each platform that is currently used to support the product and/or services used by job executors performing the core job.

The computer uses these inputs to determine which of the company criteria are most and least important for a new product/service concept, new platform concept and/or new business model to meet in order for further development. The output of this step is used in Steps 300, 320 and 330.

### Inputs for 300

The process prompts the user to input ideas or features that address the jobs target for a new platform. The output of this step is used in steps 310 and 320.

### Inputs for 310

The method prompts the user to input ideas and/or concepts of how revenue could be potentially generated by the new platform as well as how fixed and/or variable cost can be potentially reduced in the new platform. The output of this step is used in Step 340.

### Inputs for 320

The method prompts the user to input the ideas that can be supported on a predefined platform that specifically address the outcomes targeted from the core job. The user's input identifies how each feature impacts the targeted outcomes and the degree to which that outcome is affected. This could be, but not necessarily be, an expected change in the satisfaction score of a job or outcome statement.

The computer identifies the targeted outcomes that have been negatively impacted by a feature or idea and randomly selects an innovation trigger for the user to consider for creating an idea or feature that would eliminate the negative impact on that outcome.

The computer identifies the targeted outcomes that have not been positively or negatively impacted by any feature or idea and randomly selects an innovation trigger for the user to consider for creating a idea that would positively impact that outcome.

### Input for 330

The method prompts the user to input the ability of a feature or platform idea to meet the threshold values for company criteria. The computer inputs a prioritized list of company success criteria with a set of threshold values and then identifies which of these features or platform ideas fail to meet one or more of the management criteria and selects an innovation trigger for the user to consider for creating or modifying a feature to improve it's ability to meet a threshold value of one or more of the management's criteria. The output of this step goes to 320 to modify ideas or generate new platform ideas that will both address the unmet outcomes and the threshold values of the company successful criteria or to Step 340.

### Input for 340

The computer outputs from 330 and 310 are inputted along with an assessment from the user of the uniqueness of the enabling ideas for the platform, features on the platform and other processes generated. The output of 340 is a list to ideas and/or inventions that need to be protected from unlawful duplication or acquired for others.

### Market Growth Strategy Method.:

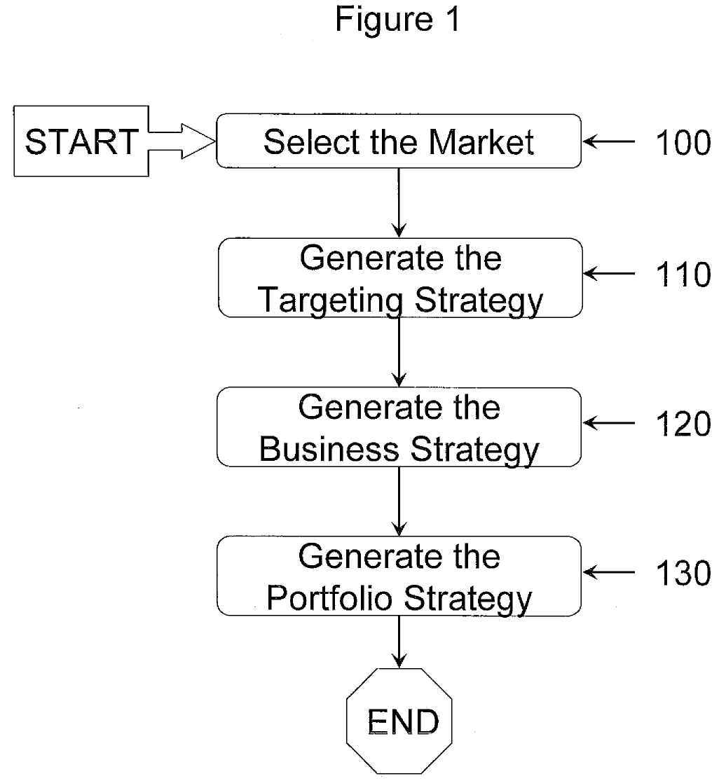

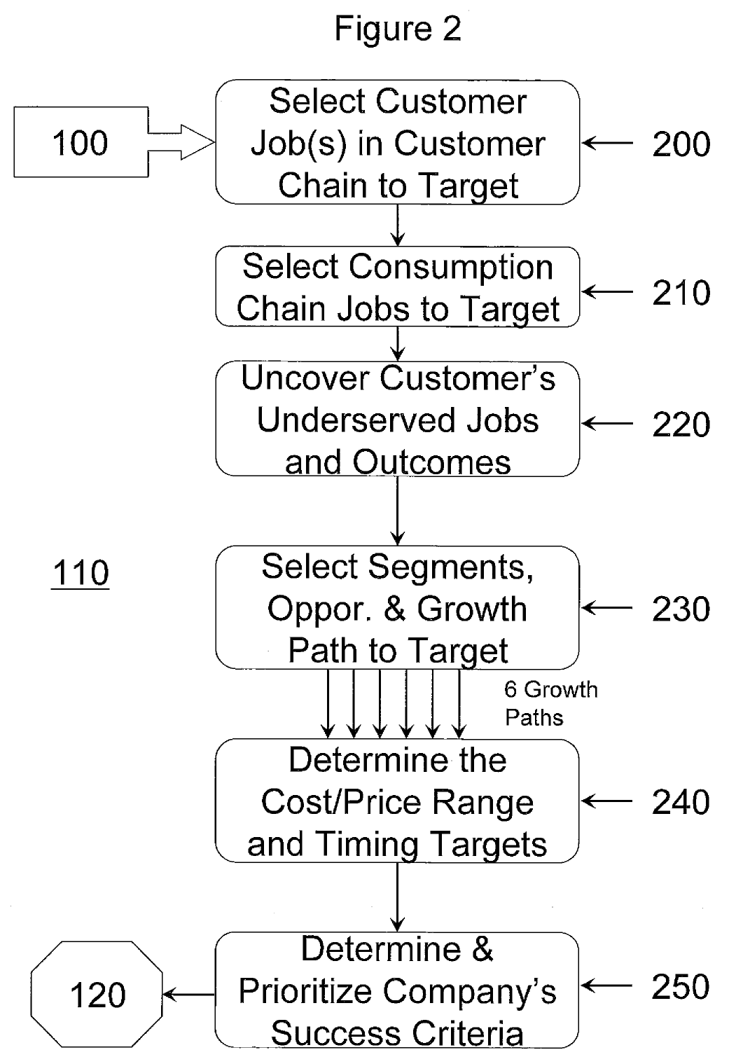

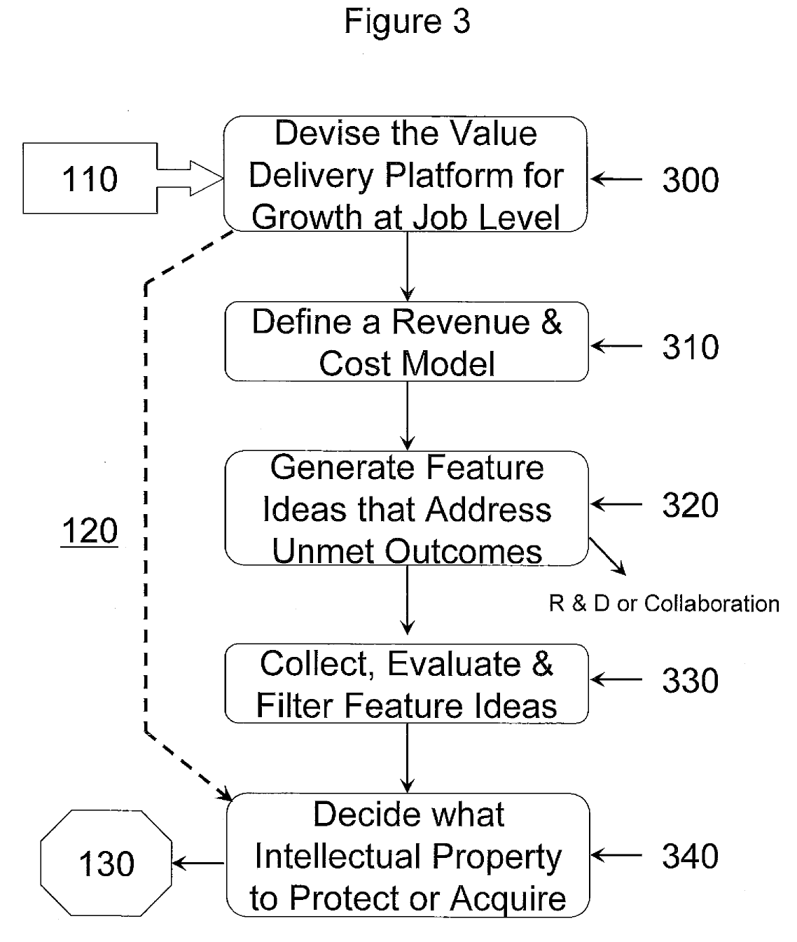

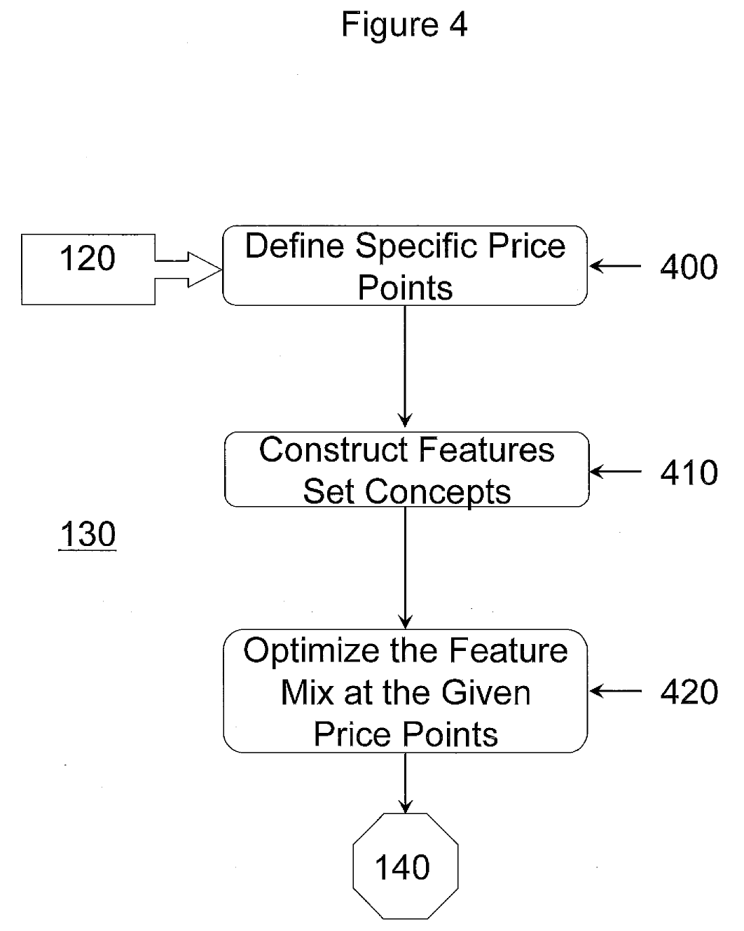

The method for creating a market growth strategy (see FIG. 1) comprises a series of sequential process steps executed in a specific order wherein the process steps are instructions stored, transferred or processed in a computer readable medium; an additional embodiment covers the business process method claims. The overall method as shown in FIG. 1 begins with the selection of the market 100. Then the process proceeds to generating a targeting strategy in step 110. The targeting strategy 110 generally involves selecting a job that is to be analyzed, uncovering and prioritizing the customer's unmet needs, devising a growth strategy (selecting a growth path) and prioritization of company criteria amongst other duties to be performed in this step. Next the business strategy is generated in step 120 that generally involves devising the delivery platform that is best, a business model and the feature set that can satisfy unmet outcomes and the filtering and protection of ideas amongst others. Finally the portfolio product strategy is generated in step 130; it is displayed, outputted to a file or printed out for easy review to one or more users. The process reaches its conclusion once the portfolio strategy has been generated. Steps 110-130 are further developed with connection to FIGS. 2-4 as described below. FIG. 2 is a flowchart representing the generation of a targeting strategy 110 utilizing the methodology of the instant invention. FIG. 3 is a flowchart representing the generation of a business strategy 120 utilizing the methodology of the instant invention. FIG. 4 is a flowchart representing the generation of a portfolio product strategy 130 utilizing the methodology of the instant invention. The entire process of generating a market growth strategy is summarized below in the proper sequence to achieve the aforementioned goals.
Select the market (FIG. 1, 100). Here, the process prompts a user representing a company to choose between a plurality of markets and determine which one(s) it wants to pursue. A market is defined here as a demographic and the job or jobs they are trying to get done. To make this decision, companies must evaluate each market in consideration against a set of company criteria, each of which must be agreed upon and prioritized by those making the decision. In most companies today, these criteria are not agreed upon, their priority is not agreed upon and the criteria that are used are not predictive of an attractive market. To overcome these issues, the invention provides the decision makers a fixed set of universal criteria that are accurate in determining which markets are most attractive for the company to pursue. To respond to some of the criteria, a minimal amount of secondary market research may be required. This is a computer implemented step associated with user inputs. The invention enables decision makers to evaluate said markets against the criteria using formulas that prioritize the markets based on their attractiveness to the company. The output of this step is the selection of one or more markets to pursue. For each market that is pursued, the subsequent steps are taken. In situations where a company is already in a market, this step may be skipped, as the goal would then be formulating a growth strategy for a market they are already in.
Select customer(s), job(s) in the customer chain to target (FIG. 2, 200). Here the process prompts the company or user to decide for whom it wants to create value. The primary target is always defined as the job executor—the person who performs the job that is being studied. Other customers may include the distributor, the purchase decision maker, the job beneficiary (the person or entity benefiting from the execution of the job) or others. The invention presents the user with a list of possible target customers with instructions on when and why to select each.
Select consumption chain jobs to target (FIG. 2, 210). Here the process prompts the company or user to decide which (if any) of the consumption chain jobs it wants to consider as a possible target for value creation. When a product or service is acquired to get a job done, customers must also consider a number of other jobs—for example, they may be forced to purchase, receive, install, set up, learn to use, interface with, transport, store, maintain, upgrade, replace and dispose of the product as well. These are called consumption chain jobs. The consumption chain jobs that are important to customers and poorly satisfied make good additional targets for value creation. The invention presents the user with a list of possible target consumption chain jobs with instructions on when and why to select each. The information needed to make the decisions must be collected from customers.
Uncover the customer's underserved jobs and outcomes (FIG. 2, 220). Here the process prompts the company or user to deconstruct the job that each target customer (job executor, distributor, etc.) is trying to get done into its discreet process steps and determine how that target customer measures the successful execution of each process step in that job. The metrics uncovered for each process step are the customer's needs. This same task is also executed for each consumption chain job that is targeted for value creation. The invention provides the user with a template to deconstruct each job. The template (a universal job map) contains and sequences the steps in which a job should optimally be executed. For the consumption chain jobs (which are universal across all products and services) the job map and needs are provided to the user as part of the invention. For the job being executed by the job executor, the metrics must be captured from customers using qualitative research methods designed for this purpose.
Select segments, opportunities and growth paths to target (FIG. 2, 230). For each job that is targeted, the process must determine which of the customer needs are unmet, where unmet is defined here as both important and unsatisfied. This determination is made using quantitative research methods designed for this purpose. The purpose of this step is to uncover opportunities for market growth. This may require segmentation analysis which is designed to uncover a segment of the overall population that has unmet (or a unique set) of unmet needs. Once all the opportunities (unmet needs) are uncovered, this information is used to formulate a market growth strategy. As part of this invention, it has been discovered that only six market growth paths exist. It has also been discovered that the growth path(s) that a company should pursue are dictated by what opportunities exist in the market. As a result, the data that has been collected when organized in this format prescribes the most effective market growth path(s) to take. Whereby in the past this decision was made poorly and with little information, the invention enables the user to quickly and accurately determine which path(s) to follow. With the growth path(s) selected, it becomes clear what unmet needs to focus on. The output of this step is used as an input into the idea generation process.
Determine the cost/price range and timing targets (FIG. 2, 240). Before idea generation can commence, company managers are prompted by the process to decide the time frame in which the to-be-generated product or service concept is required. In response to a competitive attack, for example, the time frame may be set at six months. In other situations a 2 year time frame may be acceptable. The invention requires that this input be entered into the process at this time, a practice that is not common or followed in a commonly executed in a process for market growth. Other factors that may impact timing that are considered as part of the invention include:
   Recent introduction of competitive offerings
   Planned introduction of competitive offerings
   Rate of decrease in market share
   Rate of decrease in revenue
   Obsolescence of current products
   Seasonal/cyclical purchase opportunities
   Investor expectations
   Desire to be first to market to address opportunities
In addition, at this point in the process the cost/price range for the to-be-generated product or service concept must also be entered into the process—again atypical to most processes and a step that is often poorly executed. As part of the invention, the user is presented with a cost/price algorithm that enables the company to accurately set a cost/price target. Secondary research may be required to obtain the data needed to execute this algorithm. The cost/price algorithm is listed in Appendix 1.
Determine and prioritize the company's success criteria (FIG. 2, 250). The process prompts company managers to decide what product platforms to fund, what business models to employ and what features to include on the company's products. To make these decisions, managers must agree on what criteria to use and the priority order of those criteria. The invention makes available a unique set of criteria required to effectively make these decisions. The criteria are universal across all companies and situations.

FIG. 3 has a DOTTED LINE from step 300 to step 340 where the process directs a user to protect the intellectual property that is created at the product platform level to be protected by a firm's intellectual property lawyers.

FIG. 3 has a R&D Collaboration line at step 320 where the process prompts a user or company to decide whether the people chosen to participate in the idea generation session will be internal company employees or people external to the company, e.g., customers, suppliers, specialists, etc.
Devise the value delivery platform for growth (FIG. 3, 300). Here, all the information collected and organized in the previous steps is presented by the method to those who are chosen to participate in platform-level idea generation, along with other information including (1) context around the customer need, (2) technical inputs as to why a need has not been addressed in the past and (3) insight into what intellectual property exists in this area of interest. Collectively, this information is organized and presented to idea generation participants as part of the invention. Participants use the inputs to guide their idea generation efforts and forms are presented to the user as part of the invention to capture the information that is needed to define and evaluate the alternative platform-level concepts. Concept evaluations are made by systematically evaluating a concept against all customer needs. Proprietary platform-level creativity triggers are also presented to the participants as part of the invention to help stimulate the generation of ideas.
Define a revenue and cost model (FIG. 3, 310). Here, the information collected in the previous steps is used by the process to drive the creation of a revenue and cost model (business model). As part of the invention, the idea generation participants are presented with needed information and a set of proprietary creativity triggers that direct the creation of profitable business models. Forms are presented to the user as part of the invention to capture the information that is needed to define and evaluate the alternative business model concepts. Concept evaluations are made by systematically evaluating a concept against all the company criteria previously collected from and prioritized by management.
Generate ideas that address the unmet outcomes (FIG. 3, 320). With an approved product platform and business model, idea generation participants are now guided by the method to fine-tune the product concept with the creation of a feature set that will be certain to address the customer's specific unmet needs (desired outcomes). Here, all the information collected and organized in the previous steps is presented to those who are chosen to participate in feature-level idea generation, including feature ideas that were generated during the platform-level idea generation session. Here again, as part of the invention, participants use the inputs to guide their idea generation efforts and forms are presented to the user as part of the invention to capture the information that is needed to define and evaluate the alternative feature-level concepts. Concept evaluations are made by systematically evaluating a feature concept against all related customer needs. Proprietary feature-level creativity triggers are also presented to the participants as part of the invention to help stimulate the generation of ideas.
Collect, evaluate and filter feature ideas (FIG. 3, 330). Once a product concept is defined, ongoing effort will be made to make product improvements. Here, new feature ideas will be solicited, documented and stored on a continuous and ongoing basis so that product improvement ideas are always available to the product management team.
Decide what intellectual property to protect or acquire (FIG. 3, 340). Here the process prompts a user to select what intellectual property that is created at the product feature level is to be protected by a firm's intellectual property lawyers. The form provided as part of the invention ensures the detail required for an effective filing is included as part of the idea submission.
Define specific price points (FIG. 4, 400). Here, the process prompts product managers to decide the number of product models that are needed and at what price points given the features concepts that have been generated.
Construct features set concept(s) (FIG. 4, 410). Here, feature set concepts are optimized around different price points using an algorithm included as part of the invention. The algorithm considers the overall amount of value (need satisfaction) that is generated combining different features.
Optimize the feature mix at the given price point (FIG. 4, 420). Here, those feature set concepts that that deliver the most value at the selected price points will result from executing the algorithm.

Steps 2-7 (FIG. 2, 200-250) generate the targeting strategy, steps 8-12 (FIG. 3, 300-340) generate the business strategy, and steps 13-15 (FIG. 4, 400-420) generate the portfolio strategy. The information needed for the business case supporting the strategy is collected in each of these steps. Executing the process in this order enables the correct actions to be taken at the right time and eliminates downstream actions from occurring without the needed inputs and decisions. This eliminates the need to for multiple iterations of steps in the process due to incorrect or missing input information. The inputs into each of these process steps include customer inputs, company inputs and societal inputs. The output of the process is a set of product and/or service concepts that will create value for the customer, company and society.

What has been discovered is that there exists, for each of the three constituents: the customer, the company and society, a specific set of process inputs that must be used to ensure the optimal results are achieved. These inputs, which are used to create and evaluate an effective market growth strategy, are the customer's desired outcomes (the metrics customers use to measure success when getting a job done), company success criteria (the metrics and specifications the company uses to judge the attractiveness of a value delivery platform, business model, feature idea and product and service concepts), and societal preservation criteria (the metrics society uses to judge the value of a product or service concept). These three types of inputs are always needed when formulating a market growth strategy, regardless of the industry, company and market under consideration.

### The Process Inputs

The company success criteria consist of a universal set of metrics that a company uses to determine what markets should be targeted for growth, which value delivery platforms to pursue, which business models to employ, what price point should be targeted, which product and service ideas and concepts are best as well as the company success criteria needed to transform a concept into the desire product and/or service. This finite set of metrics includes measures of financial, organizational, and technical feasibility. The company success criteria are included to shape the definition of the concept eliminating the need to redefine a concept during the development process.

As part of this market growth strategy process, the company's decision makers prioritize these universal metrics and then their organization applies them to the appropriate steps in the formulating a market growth strategy process. These metrics are used as inputs to the following steps:
Select the market (FIG. 1, 100)
Select customer(s), job(s) in the customer chain to target (FIG. 2, 200)
Select consumption chain jobs to target (FIG. 2, 210)
Select segments, opportunities and growth paths to target (FIG. 2, 230)
Determine the cost/price range and timing targets (FIG. 2, 240)
Devise the value delivery platform for growth (FIG. 3, 300)
Define a revenue and cost model (FIG. 3, 310)
Collect, evaluate and filter feature ideas (FIG. 3, 330)
Define specific price points (FIG. 4, 400)
Optimize the feature mix at the given price point (FIG. 4, 420)

The customer's acceptance criteria consist of a universal set of metrics that the customer to determine if they will accept the product/service for us. These customer criteria are related to obtaining a product or service, the financial implications of buying it, the performance issues related to using it, learning how to use it, customizing it, installing it, maintaining it, storing it and disposing of it. These customer criteria are prioritized by the targeted constituent and are used as inputs to the following steps:
Uncover the customer's underserved jobs and outcomes (FIG. 2, 220)
Generate ideas that address the unmet outcomes (FIG. 3, 320)
Collect, evaluate and filter feature ideas (FIG. 3, 330)

The societal preservation criteria consist of a universal set of metrics that are used to determine what benefits and cost the market growth strategy will have on society. For example these criteria are related to the benefits and costs a value delivery platform has on the environment or to a potential health risk and subsequent healthcare cost to society. These metrics are rated by the general public and the targeted customers and are used to understand how the ideas and concepts generated for the growth strategy align or conflict with the general public's, targeted customers' and the company's position on the impact of the market growth strategy will have on society. These society criteria are used as inputs to the following steps:
Select the market (FIG. 1, 100)
Devise the value delivery platform for growth (FIG. 3, 300)
Define a revenue and cost model (FIG. 3, 310)
Collect, evaluate and filter feature ideas (FIG. 3, 330)

In addition, another set of criteria is used as inputs into the market growth strategy that are specific to the growth target. These inputs are the jobs and the desired outcomes of a specific job for the targeted customer set. In this context, a job is defined as the fundamental goals customers are trying to accomplish or problems they are trying to solve in a given situation. (Harvard Business School professor Clayton Christensen backs this thinking in The Innovator's Solution). When the customer performs the job themselves they are referred to as the job executor, when the customer receives the benefits from a job, but they do not perform the job themselves, then they are referred to as the job beneficiary. The job is the unit of analysis from which the market growth strategy will be created and not the customer (doctors), the product category (stents) or other traditional market definition (medical device industry). The desired outcomes of a job are the metrics that the job executor and/or beneficiary use to determine the successful execution of the job. These metrics reflect the speed, precision and output that define that job. The customer's importance and satisfaction ratings of the desired outcomes of the core job as well as those of other jobs that are related to the core job are used as input for formulating a market growth strategy. These jobs and outcomes are used as inputs to the following steps:
Select which unmet needs to target (FIG. 2, 230)
Generate ideas that address unmet needs/criteria (FIG. 3, 320)
Collect and evaluate idea (FIG. 3, 330)
Decide what intellectual property to protect (FIG. 3, 340)
Optimize feature set for a given price point (FIG. 4, 420)
Select which concepts to pursue over time (FIG. 3, 330)

One unique aspect of this process is that these metrics provide all the people participating in creating and executing the market growth strategy the knowledge of the criteria from which the market growth strategy will be judged on to gain the support from the constituents that have a vested interested in the successful execution of the strategy. This information is known prior to formulating the strategy, thus lowering the probability of rejection from company decision makers, the market or society in general and eliminates to time and cost wasted on multiple iterations.

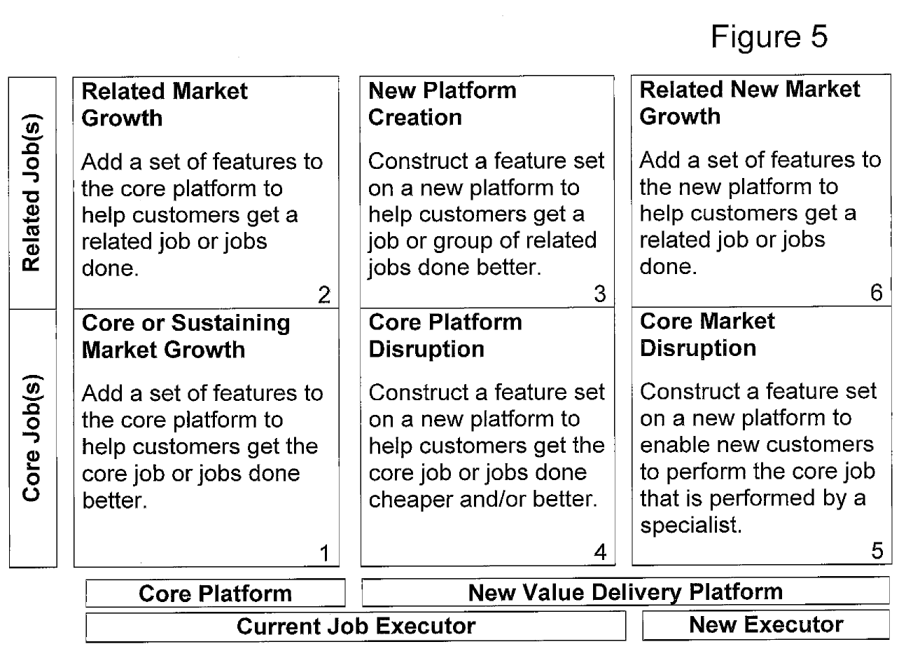

Another unique aspect of using these metrics is it makes it possible to classify the market growth strategy along 6 and only 6 potential growth paths. A value delivery platform along with a preliminary business model enables the opportunities to be satisfied along each of the growth paths. These growth paths are defined along three (3) dimensions that are shown in the vertical and horizontal perimeter of FIG. 5. These three dimensions are defined as follows:
The customer (Job executor or New executor)
The jobs that job executors perform (Core job or Related other jobs)
The value delivery platforms that enable the job executor to perform a job (Core platform or New value delivery platform)

Evaluating these three dimensions in their current (or core) state as well as in a new (or other) state creates six (6) and only six potential options to build a growth strategy around (FIG. 5). These six options are:
1. Core or Sustaining Market Growth—This growth path adds features to the core platform currently offered by the company to help customers (current job executors) get core job(s) done or that job(s) done better. By using the core platform the existing business model can be applied.
2. Related Market Growth—This growth path adds features to the current or core platform to help customers (current job executors) get other jobs related to the core job(s) done in addition to the core job(s). By using the core platform the existing business model can be applied.
3. New Platform Creation—This growth path constructs a feature set on a new platform offered by the company to help customers (current job executors) get a group of related jobs to the core job(s) done better. This new platform would enable the company to leverage a premium-price, high margin business model.
4. Core Platform Disruption—This growth path constructs a feature set on a new platform to help customers (current job executors) get the core job(s) done cheaper and/or better than with the core platform. This platform would may the company to leverage lower platform costs and/or a discounted or premium priced driven business model.
5. Core Market Disruption—This growth path constructs a feature set on a new platform to enable new customers (new job executors) perform the core job(s) currently performed by a specialist. This platform would enable the company to leverage lower-cost, premium-priced business model.
6. Related Market Growth—This growth path adds features to the new platform to help customers (new job executors) get a group of related jobs to the core job(s) done. This platform would enable the company to leverage lower-cost, premium-priced business model.

### Importance and Satisfaction Scores

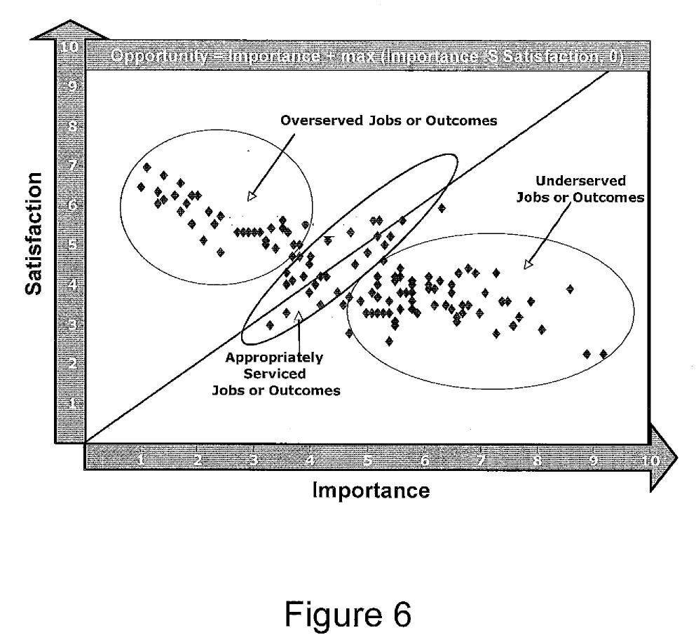

The computer program product on the computer readable medium of this invention utilizes a set of importance and satisfaction scores to determine the successful outcome of a core or related job(s). It should be noted that all individuals involved in a given process share a common set of desired outcomes. What differs from one individual to another is the importance they place on each desired outcome, and the degree to which they perceive each outcome is satisfied with respect to a given process. Therefore, the invention manipulates this information by quantifying which desired outcomes are most important or least important or anywhere between theses extremes to a given individual, a group of individuals with common interests, or the population in general. Value is created by improving an individual's or group's perceived level of satisfaction on one or more desired outcomes based on particular solutions offered to the individual or group. These importance and satisfaction scores are shown with reference to FIGS. 6-12.

In this method, a distribution set of importance and satisfaction scores is stored in a computer storage unit or database. This set comprises the outcomes for the targeted or core job to be performed and on the jobs related to the core job; it is used to determine which of the six potential growth paths have the most growth opportunity and which of these outcomes and related jobs can be addressed with the current or core platforms used by job executors. Any set of importance and satisfaction scores may have one or a combination of the 3 types of jobs or outcomes, FIG. 6.

When the importance score is greater than the satisfaction score for a job or outcome statement, that statement is referred to as underserved, when the importance score is less than the satisfaction score, that statement is referred to as overserved and when the importance and satisfaction scores are approximately equal, then the statement is referred to as appropriately served.

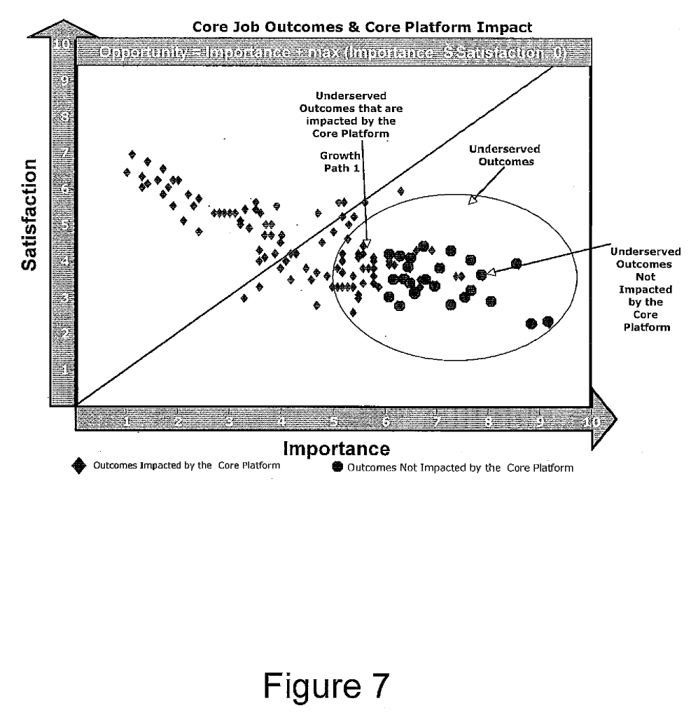

When the importance and satisfaction scores for the outcomes for the core job are underserved (the importance score is greater than the satisfaction score) and those underserved outcomes can be impacted by the core platform that is used by the job executor to perform the job, then a core or sustaining market growth path (Growth Path 1) may be considered (FIG. 7). The output from 230 identifies those underserved outcomes that can be addressed by the core platform. These outcomes may consist of all the underserved outcomes or a subset of underserved outcomes in FIG. 6 that can be.

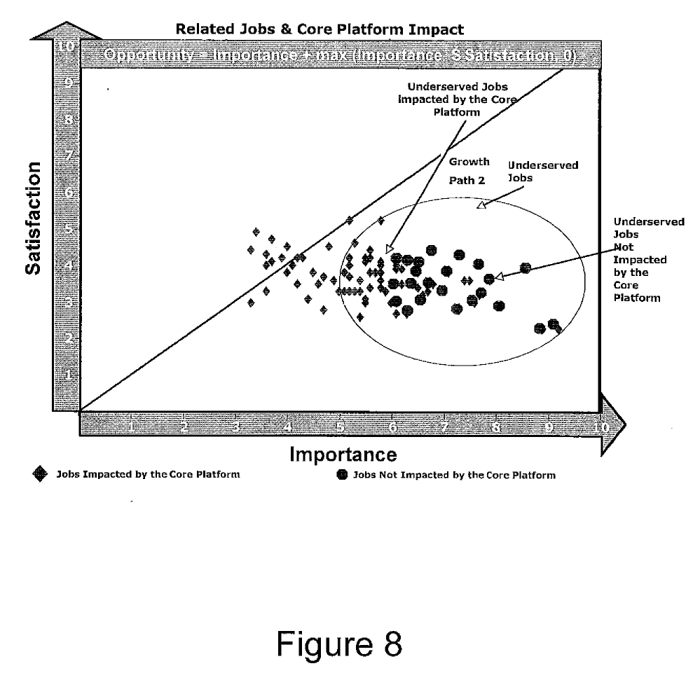

If the related jobs for the existing customer (the current job executor) are under served, (FIG. 8) and can be impacted by the core platform that is used by the job executor to perform the core job, then a Core or Sustaining Market Growth Path (Growth Path 2) should be considered if those jobs can be served without modifying the core platform to enable a feature set that will satisfy those jobs. The output from 230 identifies those underserved jobs that can be addressed by the core platform. These jobs may consist of all the underserved related jobs or a subset of the underserved jobs in FIG. 6 that can be impacted by the core platform

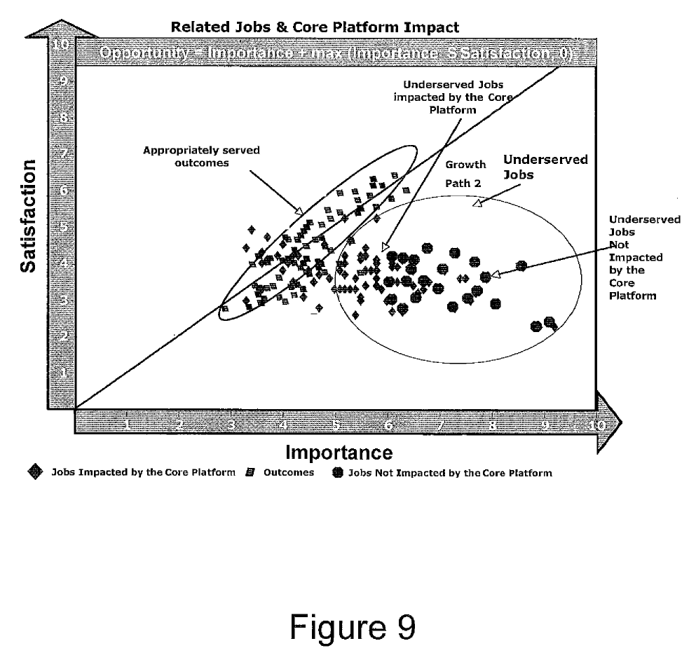

Growth Path 2 is also considered when the outcomes for the core job are appropriately served (importance˜=satisfaction) and the related jobs are underserved as shown in FIG. 9 and can be impacted by the core platform that is used by the job executor to perform the core job, The output from 230 identifies those appropriately served outcomes from the core job, the number of appropriately served outcomes and underserved jobs that can be addressed by the core platform. These jobs may consist of all the underserved related jobs or a subset of the underserved jobs in FIG. 6 that can be impacted by the core platform.

When the output from 230 reflects that the current state of the core platform is unable to impact the outcomes of the core job and/or the related jobs that were identified as underserved, then the process needs modifications to the core platform to enable a feature set to satisfy the jobs related to the core job or a new platform is used to support this feature set then a New Platform Creation Growth Path (Growth Path 3 or 4) is a potential option.

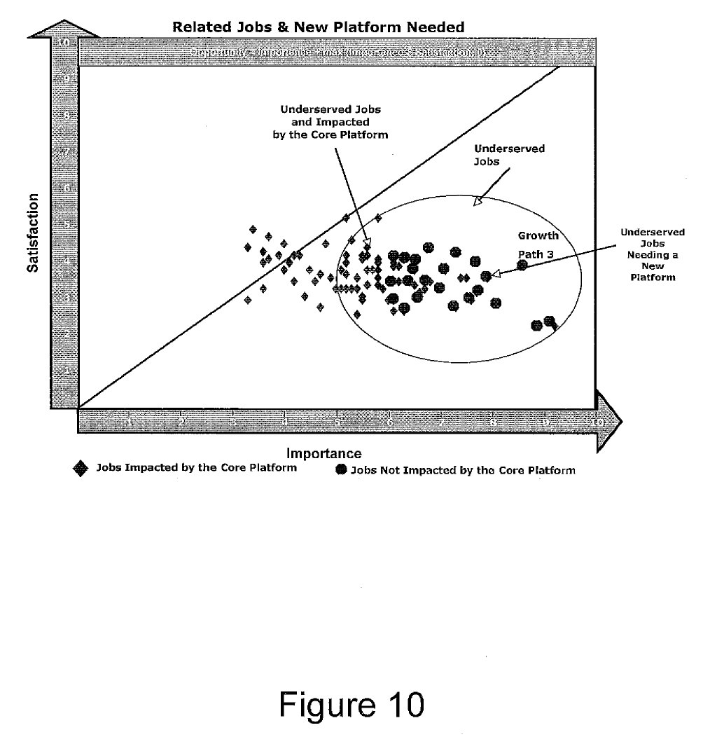

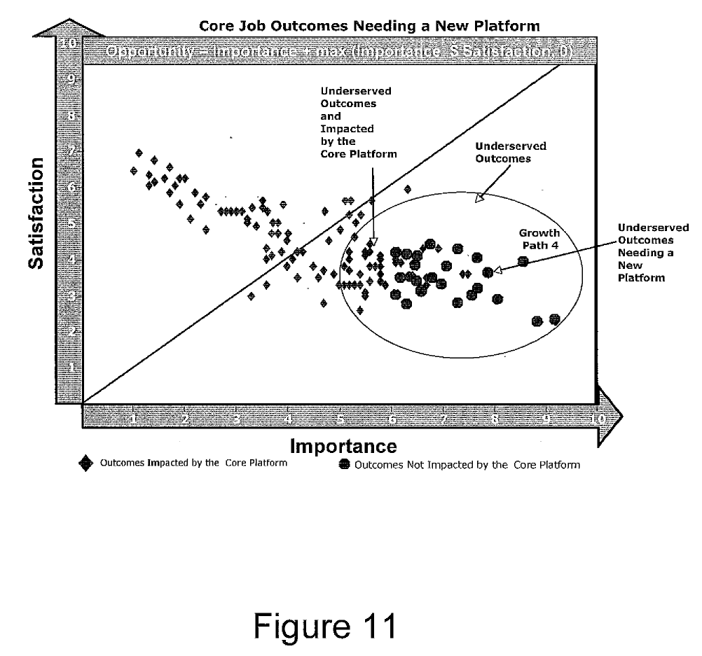

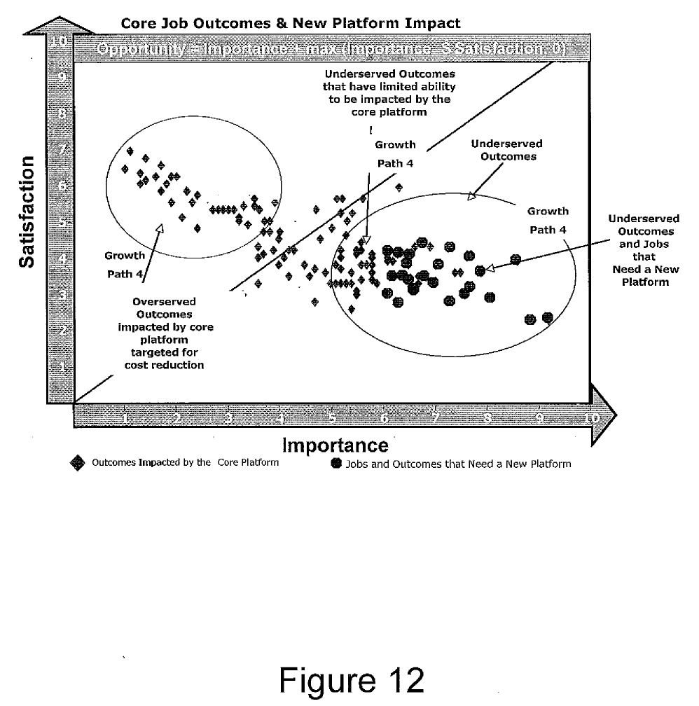

If the core platform is unable to impact the underserved related jobs then the process determines that a new platform is needed to address those jobs (FIG. 10) and Growth Path 3 is a potential option.

Several scenarios identified by the computer indicate when Growth Path 4 is a potential option. The first scenario involves the underserved outcomes and occurs when the computer output from 230 indicates that the core platform has no ability to impact the outcomes identified by the computer as underserved or when limitations of the core platform are discovered in Generating Features Ideas that Address Unmet Outcomes, 320, make it difficult to achieve the level of performance required for the job executor to experience improvements in satisfying those underserved outcomes. In either case a strategy that will require a new platform to address the underserved outcomes and may also enable the underserved jobs from Growth Path 3 to be addressed (FIG. 11).

The second scenario occurs when the computer output from 230 identifies when the job executor is over-served (importance<satisfaction) by the existing products and services enabled by the core platform. In this scenario, creating a new platform that will enable the satisfaction the underserved outcomes by lowering the platform costs as well as providing the job executor the ability to execute underserved related jobs is a potential option. The computer output from 230 identifies potential cost reducing opportunities by identifying the overserved outcomes (FIG. 12)

There are some jobs were the person that benefits from that job is not the same person that actually performs that job. These jobs typically require a unique set of skills and/or specialized equipment to perform. For example, it was just a few years ago that if a person wanted the benefits of whiter teeth, then they would go to a dentist or other specialty teeth whitening service provider to perform the job of whitening teeth. Today there are several over-the-counter teeth whitening kits that enable a person to whiten their own teeth without the need to hire a dentist or other skill professional. This made the beneficiary of the teeth whitening job the job executor. When a new platform is created to support a feature set that enables the job beneficiary to become the job executor, consequently eliminating the need for a “specialist” to perform the core job, then a Core Market Disruption Growth Path (Growth Path 5) becomes an option. As with growth path 2, when new jobs are added to a platform that created a new job executor for a core job, then the Related New Market Growth Path (Growth Path 6) is realized. The inputs from 230 are used to determine if Growth Paths 5 and 6 are possible.

Thus, a market growth strategy has been invented that overcomes the deficiencies found in the prior art. Finally, the instant invention greatly enhances the ability of organizations to implement short and long term business forecasting and enables them to rapidly implement changes to meet market needs based upon the nature of the job, the job executor and societal conditions. The following glossary of terms is useful in defining several terms that are used throughout this invention.

### Glossary of Terms

1. Innovation is the process of devising product and service concepts that address unmet customer needs and company success criteria without harming society. It results in a concept that connects with all the criteria that is being used to judge its value.
2. A job is defined as a fundamental goal a customer is trying to accomplish or problem they are trying to resolve through an action in a given situation.
3. A market is defined as a demographic (a group of people) and the core job and or related jobs they are trying to get done.
4. A need is specifically defined as a metric that customers use to measure the successful execution of a job. A need is called a desired outcome. A desired outcome can either be underserved, over served, or appropriately served.
5. Company success criteria are the set of financial, strategic and other criteria that a company uses to evaluate the attractiveness of a market, value delivery platform, business model, feature and concept.
6. Societal preservation criteria are the set of success criteria used by society to evaluate the attractiveness of a value delivery platform, feature and concept.
7. An opportunity is defined as an unmet customer need, e.g., an outcome that is both important and unsatisfied with an opportunity score>10.
8. A value delivery platform is the method or mechanism by which value is delivered to the customer, e.g., a service, technology, fleet of trucks, etc. Additionally, a value delivery platform addresses how a job will get done whereas features address how outcomes will be satisfied.
9. A feature is a tangible or intangible function that is integrated into a value delivery platform to satisfy an underserved desired outcome or a job.
10. An idea is a feature that may potentially be chosen for inclusion on a value delivery platform.
11. A product or service concept is produced when a value delivery platform is populated with the feature set that optimizes the concept for profitability, given the chosen business model.
12. A business model is the method by which a company will generate revenue from its concept offering and control costs through is operations to produce profitability for the company. A business model can be optimized around a finite set of criteria that control all aspects of profitability.
13. A growth strategy is a path a company can take to generate growth in a market. For a given market, a company can achieve growth through the execution of six possible strategies.
14. Creativity is the mental process by which an idea is triggered and conceived. Creativity is required to think of an idea (or a concept) that satisfies unmet needs and success criteria.
15. The supply chain is the upstream chain of suppliers.
16. The customer chain is the downstream set of customers.
17. The value chain is a progression that begins with raw material and ending with the sale of the finished product or service.

### Discussion of Hardware, Software and Business Method Implementation Options:

The present invention, as would be known to one of ordinary skill in the art could be produced in hardware or software, or in a combination of hardware and software. The system, or method, according to the inventive principles as disclosed in connection with the preferred embodiment and other embodiments, may be produced in a single computer system having separate elements or means for performing the individual functions or steps described or claimed or one or more elements or means combining the performance of any of the functions or steps disclosed or claimed, or may be arranged in a distributed computer system, interconnected by any suitable means as would be known by one of ordinary skill in the art.

According to the inventive principles as disclosed in connection with the preferred embodiment and other embodiments, the invention and the inventive principles are not limited to any particular kind of computer system but may be used with any general purpose computer, as would be known to one of ordinary skill in the art, arranged to perform the functions described and the method steps described. The operations of such a computer, as described above, may be according to a computer program contained on a medium for use in the operation or control of the computer, as would be known to one of ordinary skill in the art. The computer medium which may be used to hold or contain the computer program product, may be a fixture of the computer such as an embedded memory, or may be on a transportable medium such as a disk, or a fixed disk, or a memory stick, or any other type of memory as known to those of ordinary skill in the art.

The invention is not limited to any particular computer program or logic or language instruction but may be practiced with any such suitable program, logic or language, or instructions as would be known to one of ordinary skill in the art. Without limiting the principles of the disclosed invention any such computing system can include, inter alia, at least a computer readable medium allowing a computer to read data, instructions, messages or message packets, and other computer readable information from the computer readable medium. The computer readable medium may include non-volatile memory, such as ROM, Flash memory, floppy disk, disk drive memory, CD-ROM, and other permanent storage. Additionally, a computer readable medium may include, for example, volatile storage, such as RAM, buffers, cache memory, and network circuits.

Further, the computer readable medium may include computer readable information in a transitory state medium such as a network link and/or a network interface, including a wired network or a wireless network, that allow a computer to read such computer readable medium.

### Appendix 1: Cost/Price Algorithm:

The algorithm is as follows. Use data captured from customers in a valid customer survey to obtain the needed inputs.
1. Determine the amount of money the targeted customers are currently paying to get the job(s) done, e.g., money out, time spent, lost opportunity costs for the job executor, etc.
2. Determine the degree to which the job(s) is currently underserved, i.e., at job level, at outcome level
3. Determine the amount of money targeted customers are willing and able to pay to get the job(s) done perfectly
4. Select the value price
5. Select the target satisfaction level using the current satisfaction level uncovered through research as the baseline
6. Incorporate a discount for incomplete function, i.e., considering current satisfaction, perfect satisfaction, and target satisfaction level
7. Incorporate a discount for competing products, e.g., similar or substitute products, etc.
8. Incorporate a discount for fairness, e.g., within reason, unethical, etc.
9. Incorporate a discount for customer buying power, e.g., buying groups, volume buyers, etc.
10. Incorporate a discount/premium for brand value, e.g., position, culture, image, etc.
11. Select the price range upper limit
12. Set the desired profit margin at the assumed volume
13. Calculate potential revenue and profit
14. Determine if potential revenue and profit is acceptable (go, no-go, iterate)
15. Calculate the total cost upper limit (platform plus features)
16. Estimate the cost of the features needed to address all the underserved outcomes
17. Estimate the upper limit cost of the value delivery system

1. A non-transitory computer readable medium comprising multiple instructions executed in a predetermined sequence for creating a market growth strategy wherein the multiple instructions comprise the instructions of:
selecting a strategic market for the market growth strategy;
selecting core job(s) in a customer chain to target; and
selecting consumption chain jobs of the core jobs to target.

2. The computer readable medium of claim 1, further comprising instruction(s) for:
uncovering customer's underserved jobs and outcomes.

3. The computer readable medium of claim 1, further comprising instruction(s) for:
selecting segments, opportunities and growth paths to target.

4. The computer readable medium of claim 3, wherein the growth paths are defined along three dimensions comprising a customer, job(s) that customer(s) perform and a value delivery platform.

5. The computer readable medium of claim 4, wherein the customer(s) is either a job executor or a new executor.

6. The computer readable medium of claim 4, wherein the job(s) that customer(s) perform is either a core job or a related other job.

7. The computer readable medium of claim 4, wherein the value delivery platform is either a core platform or a new value delivery platform.

8. The computer readable medium of claim 4, wherein the market growth strategy is based on one of six potential growth paths, the six growth paths comprising a core or sustaining market growth path, a related market growth path, a new platform creation growth path, a core platform disruption growth path, a core market disruption growth path, and a related market growth path.

9. The computer readable medium of claim 8, further comprising instructions for:
adding features to a core platform currently offered by a company to help customer(s) get the core job(s) completed better.

10. The computer readable medium of claim 8, further comprising instruction(s) for:
adding features to a core platform to help customer(s) get other job(s) related to the core job(s) completed in addition to the core job(s).

11. The computer readable medium of claim 8, further comprising instruction(s) for:
constructing a feature set on a new platform offered by a company to help customer(s) get job(s) related to the core job(s) completed better,

12. The computer readable medium of claim 8, further comprising instruction(s) for:
constructing a feature set on a new platform to help customer(s) get a core job(s) completed cheaper and or better than with the core value delivery platform.

13. The computer readable medium of claim 8, further comprising instruction(s) for:
constructing a feature set on a new platform to enable new customer(s) to perform core job(s) currently performed by specialist(s).

14. The computer readable medium of claim 8, further comprising instruction(s) for:
adding feature(s) to a new platform to help new customer(s) to perform job(s) related to the core job(s) to their completion.

15. The computer readable medium of claim 8; wherein the six potential growth paths are evaluated using a distribution of importance and satisfaction scores to determine the growth path with the most growth opportunity.

16. A non-transitory computer readable medium comprising multiple instructions for creating a market growth strategy wherein the multiple instructions are executed in a specific sequence wherein the market growth strategy is based on one of six potential growth paths, the six growth paths comprising a core or sustaining market growth path, a related market growth path, a new platform creation growth path, a core platform disruption growth path, a core market disruption growth path, and a related market growth path.

17. The computer readable medium of claim 16, further comprising instruction(s) for:
adding features to a core platform currently offered by a company to help customer(s) get the core job(s) completed better.

18. The computer readable medium of claim 16, further comprising instruction(s) for:
adding features to a core platform to help customer(s) get other job(s) related to the core job(s) completed in addition to the core job(s).

19. The computer readable medium of claim 16, further comprising instruction(s) for:
constructing a feature set on a new platform offered by a company to help customer(s) get job(s) related to the core job(s) completed better.

20. The computer readable medium of claim 16, further comprising instruction(s) for:
constructing a feature set on a new platform to help customer(s) get a core job(s) completed cheaper and or better than with a core value delivery platform.

21. The computer readable medium of claim 16, further comprising instructions) for:
constructing a feature set on a new platform to enable new customer(s) to perform core job(s) currently performed by specialist(s).

22. The computer readable medium of claim 16, further comprising instruction(s) for:
adding feature(s) to a new platform to help new customer(s) to perform job(s) related to the core job(s) to their completion.

23. The computer readable medium of claim 16, wherein the six potential growth paths are evaluated using a distribution of importance and satisfaction scores to determine the growth path with the most growth opportunity.

24. The computer readable medium of claim 23, wherein the paths are evaluated using importance and satisfaction of outcomes that define core job(s) and the importance and satisfaction of other job(s) that customer(s) perform that are related to a core job(s).

25. The computer readable medium of claim 16, wherein the six potential growth paths are described by analyzing a set of information relating to job(s), job executor(s) and platform(s).

26. (canceled)

27. A method for generating a market growth strategy comprising the steps of:
selecting a strategic market for the market growth strategy;
selecting core job(s) in a customer chain to target; and
selecting consumption chain jobs to target;
calculating, using of a processor of a computer, an opportunity score for the consumption chain jobs;
prioritizing, using the processor, job and outcome statements based on the opportunity score.

28. The method of claim 27, further comprising step(s) for:
uncovering customer's underserved jobs and outcomes.

29. The method of claim 28, further comprising step(s) for:
selecting segments, opportunities and growth paths to target.

30. The method of claim 29, wherein the growth paths are defined along three dimensions comprising a customer, job(s) that customer(s) perform and a value delivery platform.

31. The method of claim 30, wherein the customer(s) is either a job executor or a new executor.

32. The method of claim 30, wherein the job(s) that customer(s) perform is either a core job or a related other job.

33. The method of claim 30, wherein the value delivery platform is either a core platform or a new value delivery platform.

34. The method of claim 30, Wherein the market growth strategy is classifiable in only six potential growth paths.

35. The method of claim 34, further comprising step(s) for:
adding features to a core platform currently offered by a company to help customer(s) get the core job(s) completed better.

36. The method of claim 34, further comprising step(s) for:
adding features to a core platform to help customer(s) get other job(s) related to the core job(s) completed in addition to the core job(s).

37. The method of claim 34, further comprising step(s) for:
constructing a feature set on a new platform offered by a company to help customer(s) get job(s) related to the core job(s) completed better.

38. The method of claim 34, further comprising step(s) for:
constructing a feature set on a new platform to help customer(s) get a core job(s) completed cheaper and or better than with the core value delivery platform.

39. The method of claim 34, further comprising step(s) for:
constructing a feature set on a new platform to enable new customer(s) to perform core job(s) currently performed by specialist(s).

40. The method of claim 34, further comprising step(s) for:
adding feature(s) to a new platform to help new customer(s) to perform job(s) related to the core job(s) to their completion.

41. The method of claim 34, wherein the six potential growth paths are evaluated using a distribution of importance and satisfaction scores to determine the growth path with the most growth opportunity.

42. A system, comprising:
a memory, a processor, and a datastore;
a market growth strategy engine;
a core job engine coupled to the market growth strategy engine;
a consumption chain targeting engine coupled to the core job engine;
a jobs and outcomes services engine coupled to the consumption chain targeting engine;
an opportunity and growth path targeting engine coupled to the jobs and outcomes services engine;
wherein, in operation:
the market growth strategy engine selects a strategic market for a market growth strategy based on a set of universal decision criteria;
the core job engine selects one or more core jobs in a customer chain based on the universal decision criteria;
the consumption chain targeting engine identifies one or more consumption jobs based on the one or more core jobs, a customer importance score, and a customer satisfaction score;
the jobs and outcomes services engine creates an opportunity growth plan based on the one or more consumption jobs;
the opportunity and growth path targeting engine provides a strategic market feature idea based on the opportunity growth and one or more of a project time frame, a target cost goal, and a target price.

43. The system of claim 42, wherein the universal decision criteria comprises a company success criteria, a customer acceptance criteria, or a societal preservation criteria.

44. The system of claim 42, wherein the opportunity growth path comprises a core or sustaining market growth path, a related market growth path, a new platform creation growth path, a core platform disruption growth path, a core market disruption growth path, and a related market growth path.

45. A method, comprising:
receiving a fixed set of universal criteria comprising one or more of company success criteria, customer acceptance criteria, and societal preservation criteria;
selecting a strategic market for a market growth strategy based on the fixed set of universal criteria;
selecting one or more core jobs in a customer chain based on the strategic market and a target entity;
identifying one or more consumption jobs based on the one or more core jobs, a customer importance score, and a customer satisfaction score;
creating an opportunity growth path based on the one or more consumption jobs.

46. The method of claim 45, wherein the universal decision criteria comprises a company success criteria, a customer acceptance criteria, or a societal preservation criteria.

47. The method of claim 45, wherein the opportunity growth path comprises a core or sustaining market growth path, a related market growth path, a new platform creation growth path, a core platform disruption growth path, a core market disruption growth path, and a related market growth path.

48. A product prepared by a process, comprising:
selecting one or more core jobs in a customer chain based on a strategic market and a target entity;
identifying one or more consumption job outcomes based on the one or more core jobs, a customer importance score, and a customer satisfaction score;
building a product in accordance with the identified one or more consumption job outcomes.
